(19) United States
(12) Patent Application Publication
(10) Pub. No.: US 2013/0139409 A1
(43) Pub. Date: Jun. 6, 2013

(54) WELTED FOOTWEAR

(71) Applicants: Daniel Chang(Ying-Nan), Taipei (TW); Thomas Jeffery Kelley, Del Mar, CA (US)

(72) Inventors: Daniel Chang(Ying-Nan), Taipei (TW); Thomas Jeffery Kelley, Del Mar, CA (US)

(21) Appl. No.: 13/310,351

(22) Filed: Dec. 2, 2011

(51) Int. Cl. A43B 9/00; A43D 11/00; B29D 35/12

(52) U.S. Cl. 36/83; 12/142 T

(57) ABSTRACT

An article of footwear having a shoe upper and a sandal type sole are made from an upper having a lower marginal edge with a plurality of spaced tabs extending from the lower marginal edge, a footbed having a peripheral edge, the tabs are folded over the edge onto the lower surface of the footbed, an outsole secured to the footbed and a welt strip cemented on a welt formed above the outsole and to the lower marginal edge of the upper. The welt strip is co-molded with the footbed, and thereafter separated from the footbed. In a preferred embodiment the welt strip is wrapped in fabric.

The present invention relates to footwear, especially welted footwear and method of making welted footwear.

### BACKGROUND

Footwear with un-lasted uppers is known in the art. For example, U.S. Pat. No. 7,234,248, which is hereby incorporated herein by reference, discloses a shoe comprised of an upper having a lower marginal edge with a plurality of spaced fingers or tabs extending downwardly from the lower marginal edge, a footbed or sock liner having a plurality of spaced slots or openings therein for receiving the fingers or tabs of the upper, the fingers or tabs being folded under and secured to the lower surface of the footbed, an outsole secured to the lower surface of the footbed and confining the fingers or tabs between the footbed and the outsole, and means extending around the periphery of the footbed and the lower margins of the upper for concealing the connection between the upper and the footbed.

### SUMMARY OF THE INVENTION

The present invention is an improvement to the unlasted shoe construction shown in U.S. Pat. No. 7,234,248.

In accordance with the invention, an article of footwear comprises an upper, footbed, outsole and welt strip. The upper has a lower marginal edge and a plurality of spaced tabs extending from the marginal edge. A plurality of notches are defined between the tabs, respectively. The footbed has a peripheral edge, the upper surrounding the peripheral edge of the footbed. The outsole is below the footbed. The tabs of the upper are folded over the peripheral edge and under the footbed and are secured in between the footbed and the outsole. The outsole has a peripheral edge that extends beyond the peripheral edge of the footbed to define a welt above the outsole, outside of the lower marginal edge of the upper. The welt strip is positioned on the welt and is cemented to the marginal edge of the upper to substantially seal the notches between the tabs of the upper.

A preferred embodiment of the invention comprises a fabric wrapped welt strip. A footwear upper has a lower marginal edge and a plurality of spaced tabs extending from the marginal edge such that a plurality of notches are defined between the tabs, respectively. The sole structure comprises a footbed, outsole and mid-sole there between. The footbed has a peripheral edge, such that the upper surrounds the peripheral edge of the footbed. The tabs of the upper are folded and cemented in between the footbed and the mid-sole. The mid-sole and outsole extend have substantially co-extensive peripheral edges that extend beyond the peripheral edge of the footbed to define a welt, outside the marginal edge of the upper. The welt strip is covered with a layer of fabric. The fabric wrapped welt strip is positioned on the welt and cemented to the mid-sole and the marginal edge of the upper to substantially seal the notches between the tabs of the upper.

A method of manufacturing an article of footwear in accordance with the invention comprises the steps of forming an upper with a lower marginal edge, molding a footbed, molding an outsole, the footbed and the outsole having substantially co-extensive peripheral edges, removing a peripheral strip from the marginal edges of the footbed, attaching the upper to the footbed, attaching the outsole to the footbed, and cementing the peripheral strip that was removed from the footbed to the lower marginal edge of the upper to form a welt strip above the outsole. Preferably a mid-sole is formed and positioned between the footbed and outsole. Furthermore, it is preferred to wrap the peripheral welting strip with fabric prior to cementing it to the lower marginal edge of the upper. The method of the invention does not require lasting the upper.

Additional features and advantages of the invention will become apparent to those of reasonable skill in the art from the following detailed description, as considered in conjunction with the accompanying drawings.

### BRIEF DESCRIPTIONS OF THE DRAWINGS

FIG. 1 is a perspective view of one embodiment of a shoe made in accordance with the invention;

FIG. 2 is an exploded side view of the components of the shoe shown in FIG. 1;

FIG. 3 is a plan view of the footbed, showing a welting strip separated there from;

FIG. 4 is a vertical cross-section through a side edge of of the shoe of FIG. 1; and

FIG. 5 a vertical cross-section similar to that of FIG. 4 through a side edge of a second embodiment of the shoe.

### DETAILED DESCRIPTION OF PREFERRED EMBODIMENTS

The following is a detailed description of certain embodiments of the invention presently contemplated by the inventors to be the best mode of carrying out their invention.

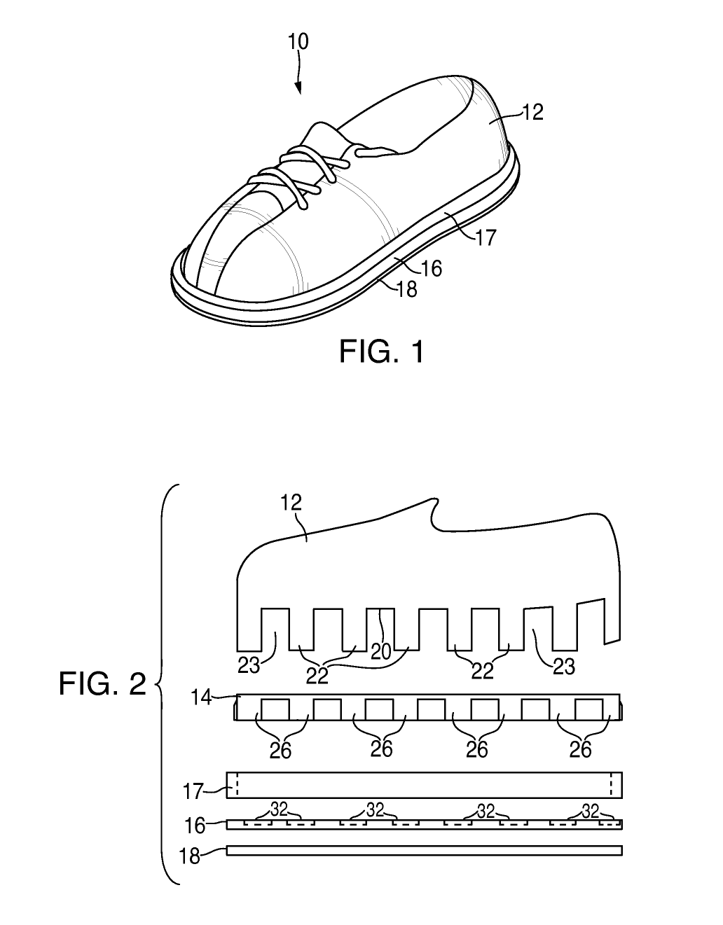

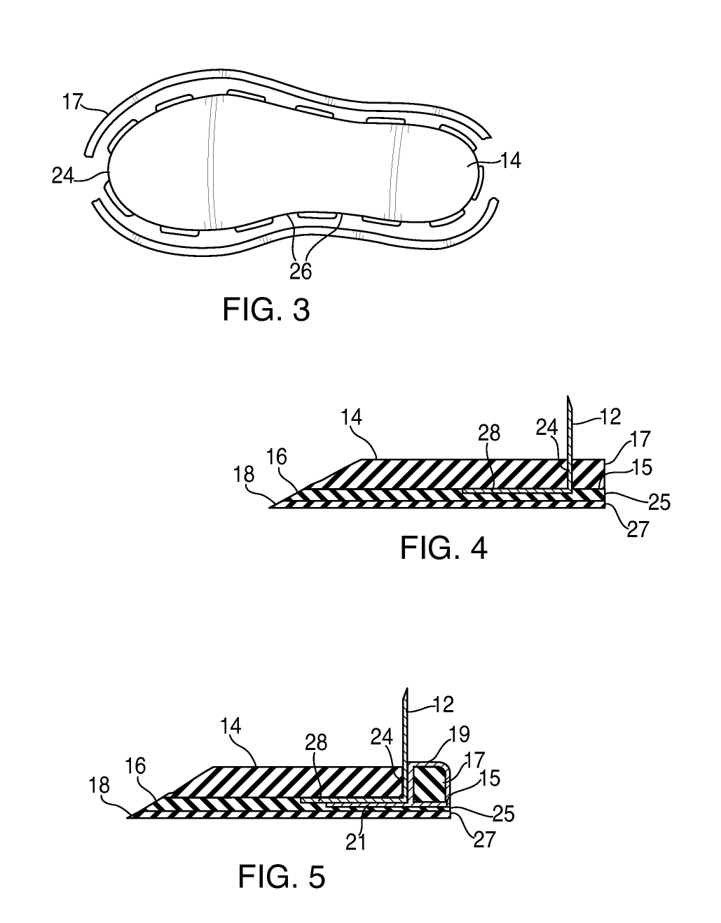

Referring to FIGS. 1-4, a shoe 10 made in accordance with the invention is comprised of an upper 12, a footbed or sock liner 14, preferably but optionally a mid-sole 16, an outsole 18, and a welt strip 17.

The upper 12 may be any conventional shoe upper, such as a lace up full shoe upper that covers the toes, instep and heel, a slip-on upper, i.e., without a heel, a loafer upper, a moccasin upper, a slipper upper and even a boot upper. The upper 12 has a lower marginal edge 20 and a plurality of spaced fingers or tabs 22 extending from the edge 20 around the periphery of the edge. A plurality of notches 23 are defined between the tabs 22, respectively.

The footbed or sock liner 14, herein referred to as footbed, may comprise any material customarily used for footbeds and is preferably cushiony material consistent with sandal design and construction, such as molded foam. The footbed has a peripheral edge 24, and may optionally include slots 26 for receiving the tabs 22 of the upper. As shown in FIG. 2, the tabs 22 on the upper 12 are of a length greater than the thickness of the footbed 14 and are folded over the peripheral edge of the footbed and against a lower surface of the footbed 14. The end portions 28 of the tabs may be and preferably are adhered to the lower surface of the footbed.

The mid-sole 16, if employed, is preferably comprised of the same material as the footbed. It has a peripheral edge 25 that extends beyond the peripheral edge of the footbed 24. The mid-sole has an upper surface and a lower surface and is adhered at its upper surface to the lower surface of the footbed 14. Preferably the mid-sole includes recesses 32 to receive the folded end portions 28 of the tabs 22, thereby to secure the tab end portions 28 between the footbed and the mid-sole. Alternatively, recesses can be provided in the bottom surface of the footbed. Use of the same materials for the lower surface of the footbed and the upper surface of the mid-sole or outsole ensures a secure bond between the two, and thus a highly reliable securement of the tab end portions within the shoe. This results in a very economical way of securing an upper to a sole structure and eliminates the need for the stitchdown or lasting board required in conventional lasted shoe constructions.

The outsole 18 may be made of any conventional outsole material and has a lower ground engaging surface and an upper surface adhered to the lower surface of the mid-sole 16. If the mid-sole is omitted from the structure, as is permissible, the upper surface of the outsole is preferably comprised of material compatible with the footbed so that they may be cemented or otherwise directly bonded to the lower surface of the footbed 14 and the folded over end portions 28 of the tabs 22 to confine and secure the tabs between the footbed and the outsole. The outsole has a peripheral edge 27 that also extends beyond the peripheral edge 24 of the footbed to form a welt 15. If a mid-sole is employed the mid-sole peripheral edge 25 and outsole peripheral edge 27 are preferably co-extensive and together form welt 15 for receiving a welt strip.

Turning now to FIG. 4, a welt strip 17 is positioned on the welt 15 and is cemented to the upper and welt. The welt strip functions to help keep water, sand and/or debris from entering the shoe through the notches 23 of the upper. The strip may be formed from any material, but is preferably formed from the same material as the footbed 14. Indeed, as described below, the footbed and welt strip maybe molded together, and thereafter, the welt strip can be separated from the footbed.

In a preferred embodiment, shown in FIG. 5 the welt strip is wrapped in a fabric layer 19. The fabric layer is preferably secured to the strip in any manner, such as by cementing the fabric to the strip. Thereafter the fabric wrapped welt strip is cemented to the lower margin of the upper 20 and welt 15. More preferably, the fabric layer includes a tail portion 21 which is configured to extend inwardly in between the footbed and outsole. Most preferably the tabs 22 of the upper and tail 21 of the welt strip are sandwiched together and cemented between the footbed 14 and mid-sole 16. The fabric wrap 19 provides design opportunities. It can be a colorful contrast to the upper 12, or can be complementary.

The assembly of the shoe 10 comprises the steps of forming the upper 12, molding a footbed 14, optionally forming a mid-sole 16, forming an outsole 18 and attaching welt strip 17. The mid-sole and outsole may be formed by any conventional process, but molding is preferred. Initially, the footbed and the outsole have substantially co-extensive peripheral edges. However, a peripheral strip 17 is removed from the marginal edges 24 of the footbed 14. Next, the upper is attached to the footbed. Although an un-lasted upper is shown as being attached with tabs to the footbed, for the purpose of the method of the invention, any type of upper can be attached in any manner to the footbed. Next, the mid-sole if one is employed and outsole are attached to the footbed. Finally, the peripheral strip 17 that was previously removed from the footbed is cemented to the lower marginal edge of the upper to form a welt strip above the outsole. In a more preferred method of the invention, peripheral welting strip is wrapped with fabric prior to cementing it to the lower marginal edge of the upper.

The assembly produces footwear wherein all of the components are adhered and sealed together in a very efficient, economical and practical manner to produce footwear that are very comfortable, practicable, and usually economical.

The objects and advantages of the invention have therefore been shown to be attained in a convenient, practical, economical and facile manner.

While preferred embodiments of the invention have been herein illustrated and described, it is to be appreciated that various modifications, rearrangements and variations may be made therein without departing from the scope of the invention as defined by the appended claims.

What is claimed is:

1. A article of footwear comprising
an upper having a lower marginal edge and a plurality of spaced tabs extending from said marginal edge, a plurality of notches being defined between the tabs, respectively,
a footbed having a peripheral edge, the upper surrounding the peripheral edge of said footbed,
an outsole below said footbed, the tabs of said upper being folded over the peripheral edge of said footbed and being secured in between said footbed and said outsole, said outsole having a peripheral edge extending beyond the peripheral edge of said footbed to define a welt above said outsole, outside the marginal edge of said upper, and
a welt strip separate from said footbed on said welt and cemented to the marginal edge of said upper to substantially seal the notches between the tabs of said upper.

2. An article of footwear as set forth in claim 1 wherein said welt strip is wrapped with a fabric, said fabric wrapped welt strip being cemented to the marginal edge of said upper and said welt.

3. An article of footwear as set forth in claim 1 further comprising fabric layer around said welt strip and having an inwardly extending tail, said tail being secured in between said footbed and said outsole.

4. An article of footwear as set forth in claim 3 further comprising a mid-sole positioned between said footbed and said outsole, the tabs of said upper and the tail of said welt strip being sandwiched together in between said footbed and said mid-sole.

5. An article of footwear as set forth in claim 1 further comprising a mid-sole positioned between said footbed and said outsole, the tabs of said upper being sandwiched in between said footbed and said mid-sole.

6. An article of footwear as set forth in claim 5 wherein at least one of said footbed and said mid-sole has recesses therein for receiving the tabs.

8. An article of footwear as set forth in claim 5 wherein said mid-sole has a peripheral edge extending substantially co-extensive with said outsole, and wherein said welt strip is cemented to a top surface of said mid-sole and the outside marginal edge of said upper.

9. An article of footwear comprising
an upper having a lower marginal edge and a plurality of spaced tabs extending from said marginal edge, a plurality of notches being defined between the tabs, respectively,
a footbed having a peripheral edge, the upper surrounding the peripheral edge of said footbed,
a mid-sole below said footbed, the tabs of said upper being folded and cemented in between said footbed and said mid-sole, said mid-sole having a peripheral edge extending beyond the peripheral edge of said footbed to define a welt above said outsole, outside the marginal edge of said upper
a welt strip covered with a layer of fabric on said welt and cemented to the mid-sole and the marginal edge of said upper to substantially seal the notches between the tabs of said upper, and
an outsole secured to the mid-sole, said outsole have a perimeter edge substantially co-extensive with said mid-sole.

10. An article of footwear as in claim 9 wherein said fabric layer includes a tail, said tail and the tabs of said upper being sandwiched together between said footbed and said mid-sole.

11. A method of manufacturing an article of footwear, comprising the steps of:
forming an upper with a lower marginal edge,
molding a footbed,
molding an outsole, the footbed and the outsole having substantially co-extensive peripheral edges,
removing a peripheral strip from the marginal edges of the footbed,
attaching the upper to the footbed,
attaching the outsole to the footbed,
cementing the peripheral strip that was removed from the footbed to the lower marginal edge of the upper to form a welt strip above the outsole.

12. A method of making footwear as in claim 11, further comprising the steps of
providing the lower marginal edge of the upper with tabs,
providing a mid-sole,
positioning the mid-sole between the footbed and outsole, and
wherein the step of attaching the upper to the footbed comprises folding the tabs of the upper under the footbed and sandwiching the tabs in between the footbed and mid-sole.

13. A method of making footwear as in claim 11, further comprising the steps of
wrapping the peripheral strip with fabric prior to cementing it lower marginal edge of the upper.

14. A method of making footwear as in claim 13, further comprising the steps of
extending the wrapping fabric inwardly to form a tail, and
securing the tail in between the footbed and outsole.

15. A method of making footwear as in claim 11, wherein the upper is not lasted.
